(19) United States
(12) Patent Application Publication
(10) Pub. No.: US 2010/0023255 A1
(43) Pub. Date: Jan. 28, 2010

(54) NAVIGATION APPARATUS, MAP DISPLAY METHOD AND MAP DISPLAY PROGRAM

(75) Inventor: Ippei Nambata, Kawagoe-Shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/445,155

(22) PCT Filed: Nov. 17, 2006
(86) PCT No.: PCT/JP2006/322978

§ 371 Date: Apr. 10, 2009

(51) Int. Cl. G01C 21/36

(52) U.S. Cl. 701/201; 701/208

(57) ABSTRACT

A navigation apparatus, which is mounted on a movable body such as a vehicle, displays a map around a present position in plural display modes which a user can designate. The map data is prepared in each display mode to be stored in a storage unit. For example, the present position of the movable body is detected by a unit such as a GPS. Then, based on the present position, a base link which is used as a basis of a display mode change is determined. Basically, the map is displayed in the display mode designated by the user. However, when the map data corresponding to the display mode designated by the user does not include the base link, the map is displayed in the display mode corresponding to the map data including the base link. The base link can be a link corresponding to the present position of the vehicle, or a scheduled travel link on a guide route.

### TECHNICAL FIELD

The present invention relates to a navigation apparatus.

### BACKGROUND TECHNIQUE

As a navigation apparatus mounted on a movable body such as a vehicle, there is known a navigation apparatus which can display a map in plural different display modes (see Patent Reference-1, for example). The plural display modes have different display forms at the time of displaying map data. For example, there is known a navigation apparatus including not only a display mode of a normal map but also a display mode of a three-dimensional (3D) map such as a bird's-eye view map and a display mode of a city map for displaying a city in detail. There is also known a navigation apparatus capable of displaying different maps at the same point.

Some navigation apparatuses of those kinds display the same map data in the different display modes, and others realize the different display modes with using map data prepared for each display mode. Recently, there is a display mode which expresses a building and a road type by three-dimensional images which look real, and the amount of map data used for it is particularly large.

On the other hand, it is required to partially update the map data used for the navigation apparatus with maintenance of new roads. However, it is difficult to update the map data having a large amount of data, such as the map data for the above three-dimensional display, in a short time. Therefore, there are actually thought some solutions: only the map data having a small amount of data is updated, and the map data having the large amount of data is not updated; or the map data having the small amount of data is updated first, and the map data having the large amount of data is updated later. In this case, the map data included in the navigation apparatus can be different in each display mode. For example, the navigation apparatus is sometimes used in such a condition that, though the map data for the normal map has already been updated, the map data for the city map has not been updated yet.

However, in such a case, the map in which the vehicle travels in a place other than a road is problematically displayed in the display mode in which the unupdated map data is used. Now, it is assumed that the map data for the normal map has been updated and the vehicle travels on the new road. The map on which the vehicle travels on the new road is displayed in the display mode for the normal map. However, since there is not the new road in the display mode in which the unupdated map data is used, the map on which the vehicle travels in the place other than the road (i.e., the place before the maintenance of the new road) is displayed. As a specific example, in such a case that the building is demolished and a new road is constructed, the map on which the vehicle travels in the demolished building is displayed in the display mode in which the unupdated map data is used.

For the purpose of the solution for this problem, there is such a method that the update of the map data is managed by a mesh unit, and if there is only one unupdated part in the map data, the map display in the display mode is made invalid. However, in such a case, since only the one road in the mesh is not updated, the map display of the entire meshes in the specific display mode is made invalid. Thus, the opportunity for the user to use the display mode is reduced. In addition, the map data prepared for the display mode cannot be effectively used.

Patent Reference-1: Japanese Patent Application Laid-open under No. 2003-232638

### DISCLOSURE OF INVENTION

### Problem to be Solved by the Invention

The present invention has been achieved in order to solve the above problem. It is an object of this invention to provide a navigation apparatus capable of appropriately displaying a map in each display mode even when update situations of map data used in the plural display modes are not coincident.

In the invention according to claim 1, a navigation apparatus for a movable body, includes: a storage unit which stores map data prepared for each display mode; a present position detection unit which detects a present position of the movable body; a base link determination unit which determines a base link, which is used as a basis of a display mode change, based on the present position; and a map display unit which displays a map in a display mode designated by a user, wherein, when map data corresponding to the display mode designated by the user does not include the base link, the map display unit displays a map in the display mode corresponding to the map data including the base link.

In the invention according to claim 6, a map display method in a navigation apparatus for a movable body including map data for each display mode, includes: a present position detection process which detects a present position of the movable body; a base link determination process which determines a base link which is used as a basis of a display mode change, based on the present position; and a map display process which displays a map in a display mode designated by a user, wherein, when map data corresponding to the display mode designated by the user does not include the base link, the map display process displays a map in the display mode corresponding to the map data including the base link.

In the invention according to claim 7, a map display program executed in a navigation apparatus for a movable body including a computer, makes the computer function as: a storage unit which stores map data prepared for each display mode; a present position detection unit which detects a present position of the movable body; a base link determination unit which determines a base link which is used as a basis of a display mode change, based on the present position; and a map display unit which displays a map in a display mode designated by a user, wherein, when the map data corresponding to the display mode designated by the user does not include the base link, the map display unit displays a map in a display mode corresponding to the map data including the base link.

### BRIEF DESCRIPTION OF THE DRAWINGS

FIG. 1 is a block diagram showing a configuration of a navigation apparatus according to an embodiment;

FIG. 2 schematically shows a structure of map data used in the embodiment of the present invention;

FIGS. 3A and 3B show a structure of road data and a structure of link data, respectively;

FIGS. 4A and 4B are diagrams for explaining a link and a node;

FIGS. 5A to 5D show display examples of various kinds of display modes;

FIG. 6 is an example of a correspondent table showing existence or nonexistence of the link data in each display mode;

FIGS. 7A and 7B show map display examples at a time of traveling on a new road;

FIG. 8 shows a map display example at the time of traveling on the new road in the embodiment;

FIG. 9 is a flow chart of a map display process according to a first embodiment;

FIG. 10 is a flow chart of a map display process according to a second embodiment;

FIG. 11 is a flow chart of a map display process according to a third embodiment; and

FIG. 12 is a flow chart of a map display process according to a fourth embodiment.

### BRIEF DESCRIPTION OF THE REFERENCE NUMBER

10 Stand-alone position measurement device

18 GPS receiver

20 System controller

22 CPU

36 Data storage unit

40 Display unit

60 Input device

100 Navigation apparatus

### DETAILED DESCRIPTION OF THE PREFERRED EMBODIMENTS

According to one aspect of the present invention, there is provided a navigation apparatus for a movable body, including: a storage unit which stores map data prepared for each display mode; a present position detection unit which detects a present position of the movable body; a base link determination unit which determines a base link which is used as a basis of a display mode change, based on the present position; and a map display unit which displays a map in a display mode designated by a user, wherein, when map data corresponding to the display mode designated by the user does not include the base link, the map display unit displays a map in the display mode corresponding to the map data including the base link.

The above navigation apparatus is mounted on the movable body such as a vehicle, and executes the map display around the present position in the plural display modes which the user can designate. The map data is prepared for each display mode, and is stored in the storage unit. For example, the present position of the movable body is detected by a unit such as a GPS, and the base link which is used as a basis of the display mode change is determined on the basis of the present position. Basically, the map is displayed in the display mode designated by the user. However, when the map data corresponding to the display mode designated by the user does not include the base link, the map is displayed in the display mode corresponding to the map data including the base link. Thus, in such a case that the map data is not newest in the display mode designated by the user and the road on which the vehicle presently travels cannot be displayed, the display mode is automatically changed into the display mode in which the present road can be accurately displayed.

In a manner of the above navigation apparatus, the base link may be a link corresponding to the present position. In this manner, when the link corresponding to the present position cannot be displayed in the display mode designated by the user, the display mode is changed.

In another manner, the above navigation apparatus may further include a route guide unit which guides a route to a destination in accordance with a guide route, and the base link may be at least one scheduled travel link positioned ahead of a road link corresponding to the present position on the guide route. In this manner, when the link in which the vehicle is scheduled to travel in accordance with the route guide in the display mode designated by the user cannot be displayed, the display mode is changed.

In still another manner of the above navigation apparatus, the base link may be a link connected to a node which is connected to the link corresponding to the present position in a traveling direction of the movable body. In this manner, when the link connected to the node ahead of the link in which the vehicle presently travels, i.e., the link in which the vehicle is scheduled to travel next, cannot be displayed in the display mode designated by the user, the display mode is changed.

In still another manner of the above navigation apparatus, when the present position is not on a road in the map data corresponding to the display mode designated by the user, the map display unit may display the map in the display mode including the base link and corresponding to the map data in which the present position is on the road. In this manner, when the base link cannot be displayed in the display mode designated by the user, or when the present position is not on the road, the display mode is changed into the display mode in which the map display is accurately executed.

According to another aspect of the present invention, there is provided a map display method in a navigation apparatus for a movable body including map data for each display mode, including: a present position detection process which detects a present position of the movable body; a base link determination process which determines a base link which is used as a basis of a display mode change, based on the present position; and a map display process which displays a map in a display mode designated by a user, wherein, when map data corresponding to the display mode designated by the user does not include the base link, the map display process displays a map in the display mode corresponding to the map data including the base link. By the method, when the map data is not newest in the display mode designated by the user and the road on which the vehicle presently travels cannot be displayed, the display mode is automatically changed into the display mode in which the map display can accurately display the present road.

According to still another aspect of the present invention, there is provided a map display program executed in a navigation apparatus for a movable body including a computer, making the computer function as: a storage unit which stores map data prepared for each display mode; a present position detection unit which detects a present position of the movable body; a base link determination unit which determines a base link which is used as a basis of a display mode change, based on the present position; and a map display unit which displays a map in a display mode designated by a user, wherein, when the map data corresponding to the display mode designated by the user does not include the base link, the map display unit displays a map in a display mode corresponding to the map data including the base link.

When the computer executes the program, the above-mentioned navigation apparatus can be realized. The above program can be preferably used in a condition of being stored onto the storage medium.

### Embodiment

Now, a description will be given of a preferred embodiment of the present invention with reference to attached drawings. The explanation which will be given below shows such an example that the present invention is applied to an on-vehicle navigation apparatus

### [Navigation Apparatus]

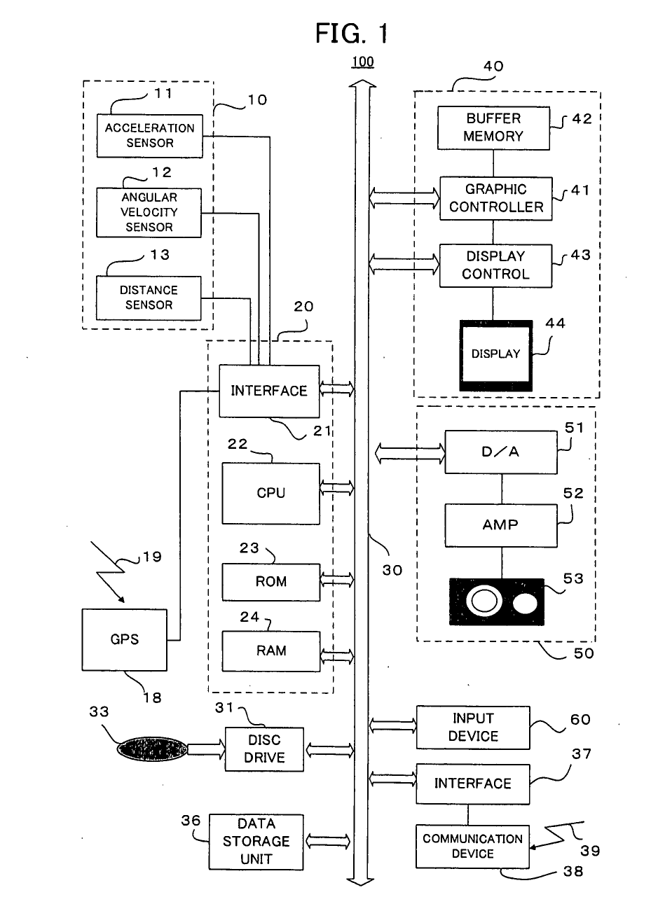

FIG. 1 shows a configuration of a navigation apparatus 100 according to an embodiment of the present invention. As shown in FIG. 1, the navigation apparatus 100 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation apparatus 100.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data.

The communication device 38 includes an FM tuner, a beacon receiver, a mobile phone and a dedicated communication card, for example, and obtains road traffic information such as traffic jam and traffic information and other information, delivered from a VICS (Vehicle Information Communication System) center via the communication interface 37.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of anon-vehicle electric system loaded on the vehicle. Additionally, in such a case that the display 44 is in a touch panel system, a touch panel provided on the display screen of the display 44 functions as the input device 60, too.

By executing a program stored in the ROM 23, the CPU 22 functions as a present position detection unit, a base link determination unit, a map display unit and a route guide unit.

### [Map Data]

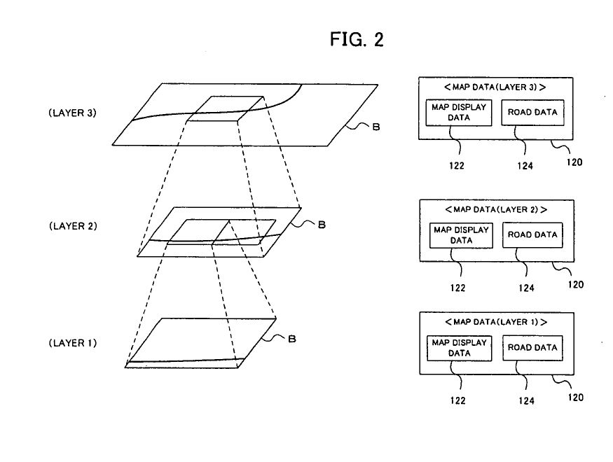

FIG. 2 schematically shows a structure of map data used in this embodiment. The map data is formed as a hierarchic structure including plural layers corresponding to plural different scales. FIG. 2 illustrates the map data including three layers for convenience of explanation, but the map data may include much more layers. In each layer, a single unit of the map data is referred to as “Block B”. “Block” is a concept indicating a range having a geographical spread, and can be also expressed by “Parcel” and “Mesh”. In FIG. 2, a layer 3 is the highest layer, and corresponds to the widest map. A layer I is the lowest layer, and corresponds to the most detailed map.

Map data 120 is separately prepared for each layer, and includes map display data 122 and road data 124, respectively. The map display data 122 is used for displaying a map image to the user, and mainly includes image data corresponding to the map. The road data 124 shows nodes forming the road and road links (also simply referred to as “links”), and is used for map display and route search.

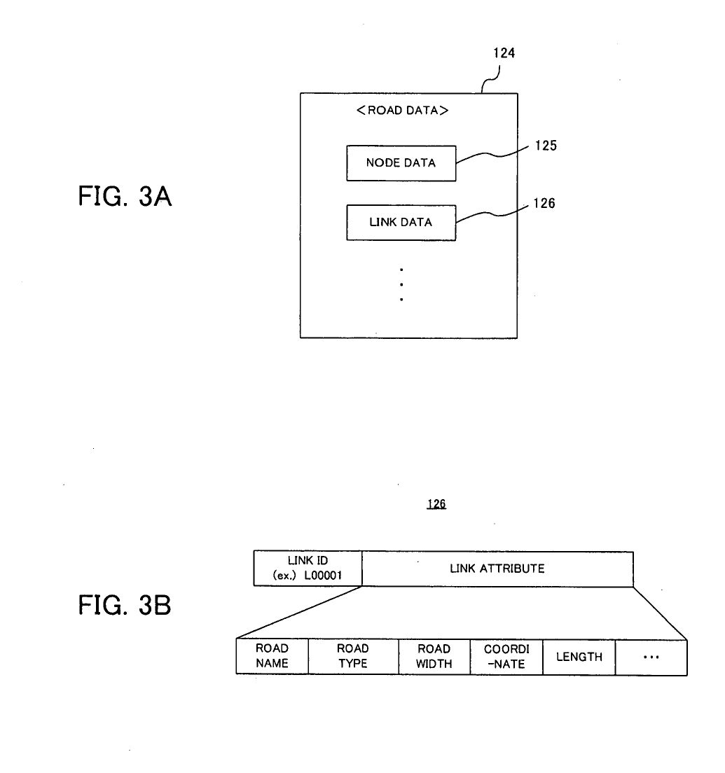

FIG. 3A shows the structure of the road data 124. The road data 124 includes node data 125 and link data 126. The node corresponds to a predetermined point such as an intersection on a rode, and the node data 125 shows the node. Meanwhile, the link corresponds to a segment sectioned by the intersection on the road, and the link data 126 shows the link.

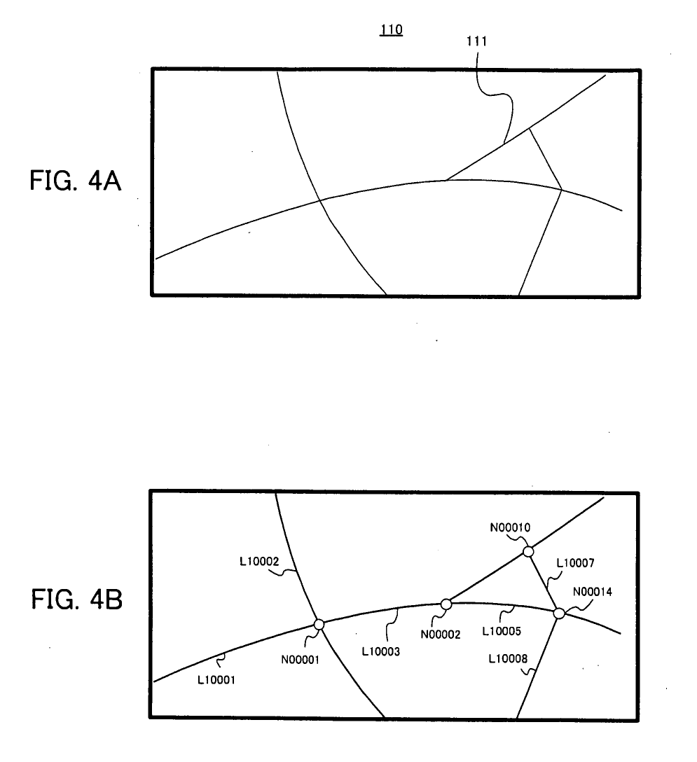

FIGS. 4A and 4B show examples of the nodes and the links. A map including plural roads 111, shown in FIG. 4A, is formed by the plural nodes and links as shown in FIG. 4B. In FIG. 4B, each node is shown by a node ID (e.g., N0001), and each link is shown by a link ID (e.g., L0001).

FIG. 3B shows a structural example of link data. The link data 126 includes a link ID and a link attribute. The link ID is information which identifies each link, and is uniquely given to each link. The link attribute is information which shows the attribute of the link, and includes a road name, a road type, a road width, a coordinate, a length and the like.

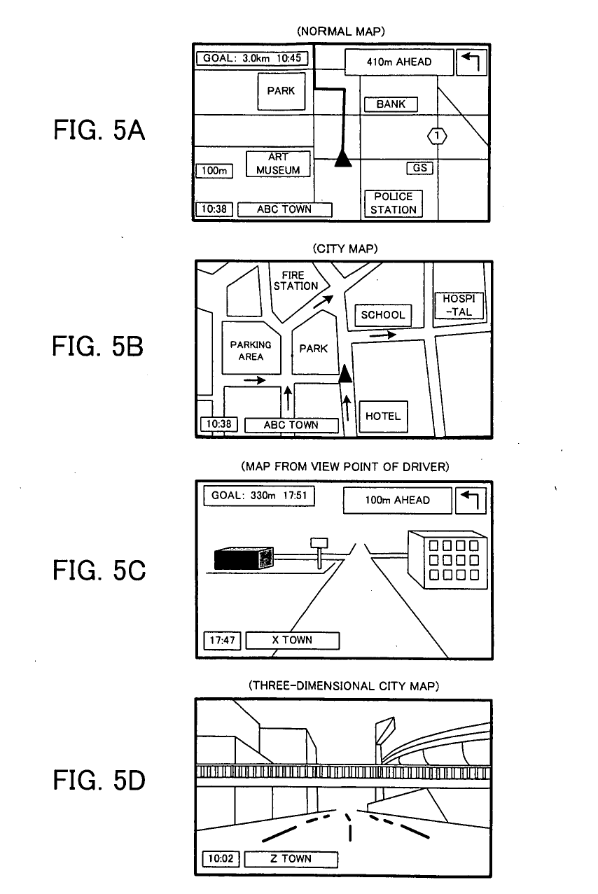

The navigation apparatus 100 can display a map in plural display modes, and the map data is basically prepared for each display mode. In this embodiment, the navigation apparatus 100 can display the map in four modes, i.e., a normal map, a city map, a map from a view point of a driver and a three-dimensional city map. FIGS. 5A to 5D show display examples of the respective display modes. FIG. 5A shows the display example of the normal map, and FIG. 5B shows the display example of the city map. FIG. 5C shows the display example of the map from the view point of the driver, and FIG. 5D shows the display example of the three-dimensional city map. The normal map is most normally used, and is a plane (two-dimensional) map which mainly shows roads. The city map is a plane (two-dimensional) map which displays not only roads but also buildings and facilities in a city in detail. The map from the view point of the driver is a birds-eye view diagram (three-dimensional drawing) which sees the forward direction of the vehicle from the view point of the driver. The three-dimensional city map is a single view drawing which mainly three-dimensionally displays the buildings and facilities in the city.

In order to realize the map display in the plural display modes, the map data 120 is basically prepared for each display mode. Namely, the map data 120 includes the map data for the normal map, the map data for the city map, the map data for the map from the view point of the driver and the map data for three-dimensional city map.

In some display modes, the map data is not prepared for all the layers. For example, the map data for the normal map is prepared for all the layers. Meanwhile, since the city map, the map from the view point of the driver and the three-dimensional city map are suitable for displaying comparatively narrow area, the map data for them is prepared only in the lowest layer 1 or only in the layers 1 and 2.

Also, in some display modes, the map data is not prepared for all the areas (blocks). For example, the map data for the normal map is prepared for all the blocks. However, the map data for the city map is prepared for only the block of the city.

### [Map Display Process]

Next, a description will be given of a map display process of the present invention.

As described above, the map data 120 is basically prepared for each display mode. However, the newest map data corresponding to all the display modes is not always prepared similarly. Normally, the map data is constantly updated in correspondence with the maintenance of the new road. When the map data is updated, the map data for the normal map being the standard display mode is generally updated first. Meanwhile, the map data for the city map, the map data for the map from the view point of the driver and the map data for the three-dimensional city map are updated later than the map data for the normal map, or they are not updated in some cases. Particularly, since the three-dimensional image is used for the map from the view point of the driver and the three-dimensional city map, the amount of map data is large, and it takes a long time to update the map data. Therefore, it can actually happen that only the map data for the normal map is updated to be newest and the map data corresponding to the display modes of the maps other than the normal map is not updated, as to the map data stored in the navigation apparatus 100.

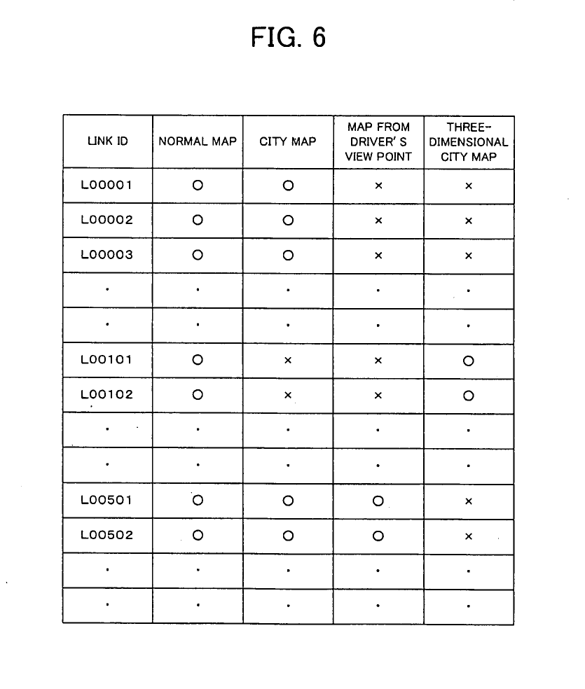

FIG. 6 is a table which schematically shows existence or nonexistence of the link data in the map data corresponding to each display mode. Generally, in the map data in each display mode, the same link ID is usually given to the same link. Thus, according to the rule, the link ID is given in this embodiment, too. In this example, all the map data for the normal map is updated, and the link data of all the links is prepared. Meanwhile, the map data for the city map, the map data for the map from the view point of the driver and the map data for the three-dimensional city map are only partly updated. Therefore, when a certain link is taken notice of, the link data can be displayed in a certain display mode, but the link data cannot be displayed in the other display mode.

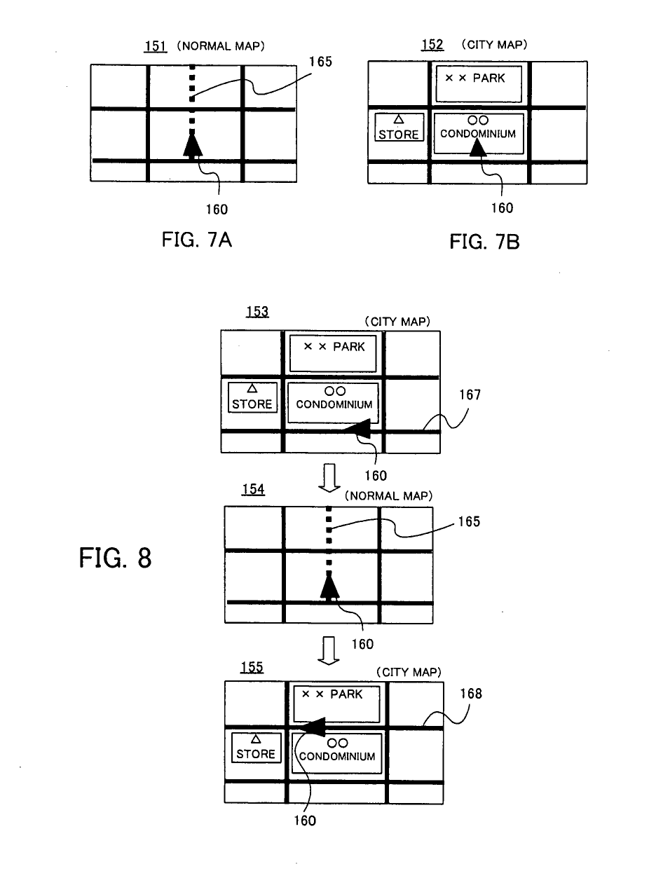

FIGS. 7A and 7B show map display examples in such a case that the update situations of the maps are different. FIG. 7A shows the display image example of the normal map, and FIG. 7B shows the display image example of the city map. As shown in FIG. 7A, the vehicle on which the navigation apparatus 100 is mounted travels on a road 165, and a present position mark 160 of the vehicle moves on the road 165. Now, it is assumed that the road 165 is a new road recently opened up and the link data corresponding to the road exists in the map data for the normal map but it does not exist in the map data for the city map. In this case, if the user chooses the normal map as the display mode, the present position mark 160 moves on the new road 165, as shown by a display image 151 in FIG. 7A. Therefore, there is no problem. However, if the user chooses the city map as the display mode, the present position mark 160 moves in a place having no road, as shown in FIG. 7B. Now, this situation will be explained in detail. The navigation apparatus 100 uses the map data for the normal map, and specifies the road link corresponding to the present position of the vehicle to move the present position mark 160. Thus, the present position mark 160 moves on the position at which the new road 165 actually exists on the display image 152. However, since the map data for the city map does not include the link data of the new road 165, the present position mark 160 moves in the place which is not on the road on the display image 152.

Hence, in this embodiment, the navigation apparatus 100 automatically switches the display mode to the display mode in which the correspondent link data exists, when the vehicle travels or is going to travel into the road link having no correspondent link data in the present display mode. Specifically, the navigation apparatus 100 determines the base link which is used as the basis of the display mode change, based on the present position of the vehicle. Then, when the map data corresponding to the present display mode does not include the link data of the base link, the navigation apparatus 100 changes the map display into the other display mode having the link data of the base link. Hereinafter, plural embodiments will be explained.

### First Embodiment

In a first embodiment, the link corresponding to the present position of the vehicle is used as the base link. FIG. 8 shows a map display example according to the first embodiment. It is assumed that the user chooses the city map as the display mode. It is also assumed that the new road 165 is actually constructed and the link data corresponding to the new road is included in the map data for the normal map but it is not included in the map data for the city map.

On the display image 153 of the city map, the present position mark 160 moves on a road 167. Now, it is assumed that the vehicle turns right on the road 167 and travels into the new road 165. The navigation apparatus 100 detects that the map data for the city map does not include the new road 165, and automatically changes the display mode into the normal map having the new road 165. As a result, a display image 154 of the normal map is displayed.

On the display image 154 of the normal map, the present position mark 160 moves on the new road 165. The vehicle further keeps traveling, and turns left on the new road 165. Then, the vehicle travels into a road 168. The navigation apparatus 100 detects that the map data for the city map designated by the user includes the link data of the road 168, and automatically returns the display mode to the display mode for the city map. As a result, the display image 155 of the city map is displayed.

As described above, in the first embodiment, when the link data of the road corresponding to the present position of the vehicle does not exist in the map data corresponding to the display mode designated by the user, the navigation apparatus 100 automatically switches the display mode to the other display mode having the link data. Therefore, as explained with reference to FIGS. 7A and 7B, it can be prevented to display the map in which the vehicle travels in the place other than the road.

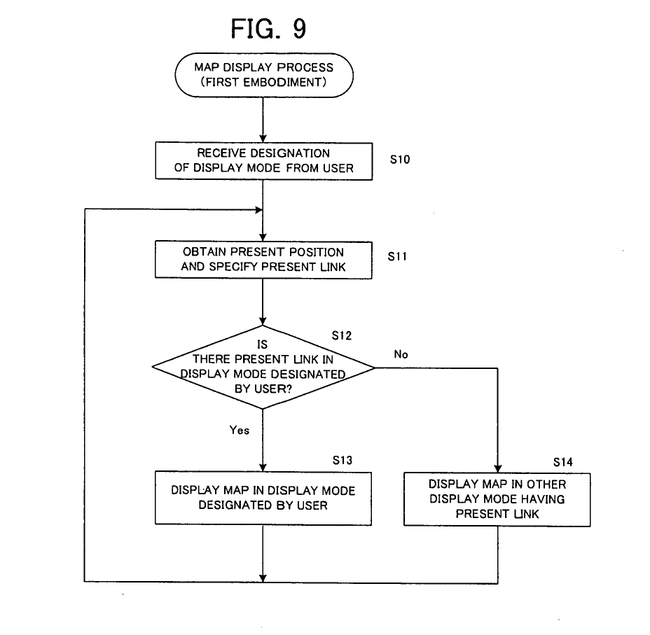

Next, a description will be given of a map display process. FIG. 9 is a flow chart of the map display process according to the first embodiment. When the CPU 22 shown in FIG. 1 executes the map display program prepared in advance, this process is realized.

First, the CPU 22 receives the designation of the display mode from the user via the input device 60 (step S10). Next, the CPU 22 obtains the present position of the vehicle with using the stand-alone position measurement device 10 and the GPS receiver 18, and refers to the map data for the normal map to specify the link ID of the link (hereinafter also referred to as “present link”) corresponding to the present position (step S11). In the first embodiment, the present link corresponds to the base link in the present invention. The present position of the vehicle can be obtained as the positional coordinate shown by longitude and latitude. In addition, the present link can be determined by comparing the positional coordinate of the present position with the coordinate in the link data shown in FIG. 3B.

Next, the CPU 22 determines whether or not the link data of the present link is included in the present display mode, i.e., in the map data corresponding to the display mode designated by the user in step S10 (step S12). When the link data of the present link is included (step S12; Yes), the CPU 22 displays the map in the display mode designated by the user (step S13). Meanwhile, when the link data of the present link is not included (step S12; No), the CPU 22 displays the map in the other display mode having the link data of the present link (step S14). Concretely, the CPU 22 refers to the correspondent table schematically shown in FIG. 6, and determines the display mode having the link data corresponding to the present link. When there are plural display modes having the link data corresponding to the present link, any of them maybe basically employed. However, if there is the display mode preferred by the user on the basis of history data, the display mode may be prioritized. For example, if the number of designations of the user in the past display modes proves that the user likes the city map, the map from the view point of the driver, the three-dimensional city map and the normal map in this order, the display mode may be determined in this order.

Since the correspondent table shown in FIG. 6 is illustrated for the explanation, it is not always necessary to prepare the data corresponding to the correspondent table of this kind and store it in the navigation apparatus 100. As described above, since the same link ID is normally given to the same link in the map data used in the different display mode, even if the data of the correspondent table shown in FIG. 6 is not prepared, the CPU 22 may refer to each map data to determine whether or not the link data of the link ID corresponding to the present link exists. Needless to say, the data of the correspondent table shown in FIG. 6 may be independently prepared for the purpose of rapid procedure.

### Second Embodiment

In a second embodiment, there is used the link existing ahead of the link including the present position of the vehicle (i.e., near to the destination) on a guide route by a route guide function, as the base link.

In the first embodiment, the present link corresponding to the present position of the vehicle is used as the base link. When the map data corresponding to the present display mode does not include the link data of the present link, the display mode is changed. However, according to this method, the display mode is switched after the vehicle travels into the link having no link data. Therefore, even if it is understood that the link ahead does not include the link data, the display mode is not switched until the vehicle actually travels into the link. It may be late to change the display mode based on the present link. Hence, in the second embodiment, it is determined whether or not the link data exists in the present display mode as to the link (also referred to as “scheduled travel link”) ahead of the present link on the guide route set during the route guide, and the display mode is changed. Concretely, the process is executed by prescribing the base link as the scheduled travel link.

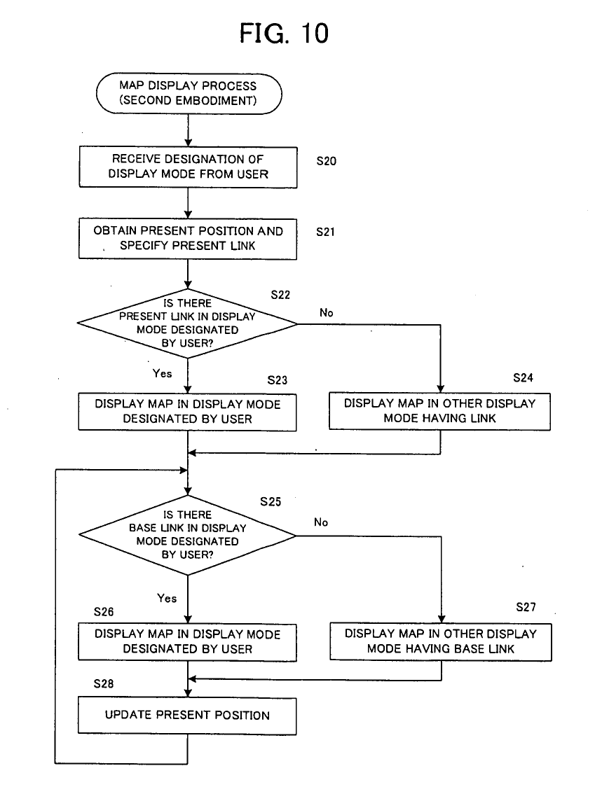

FIG. 10 is a flow chart of the map display process according to the second embodiment. When the CPU 22 executes the map display program prepared in advance, this process is realized.

In FIG. 10, processes in steps S20 to S24 are same as those in steps S10 to S14 in FIG. 9, and thus, explanations thereof are omitted. In the display mode designated by the user (step S23) or in the display mode having the link data of the present link (step S24), the map is displayed. In this state, the CPU 22 determines whether or not the map data corresponding to the display mode designated by the user includes the link data of the base link (step S25). When the display mode designated by the user includes the link data of the base link, the CPU 22 displays the map in the display mode (step S26). Meanwhile, when the display mode designated by the user does not include the link data of the base link, the CPU 22 displays the map in the other display mode having the link data of the base link (step S27). Afterward, the CPU 22 updates the present position (step S28), and repeatedly executes the processes in steps S25 to S27.

According to the second embodiment, the display mode is changed by prescribing the link of the scheduled travel link on the guide route as the base link. Therefore, it can be prevented that the display mode is switched after the vehicle actually travels into the link having no link data, i.e., that changing the display mode is delayed.

In the second embodiment, the base link is the link positioned ahead of the present link on the guide route, i.e., the scheduled travel link. Specifically, the base link may be the scheduled travel link positioned next to the present link on the guide route, or may be the scheduled travel link which is two links ahead of the present link, or may be the scheduled travel link further ahead of the present link. Also, the navigation apparatus 100 may switch the map display into the display mode having the link data corresponding to all of the plural scheduled travel links positioned ahead of the present link. For example, when there is a single link, in all the links forming the guide route and included on the present display screen, which has no link data in the display mode designated by the user, the map display may be changed into the other mode having the link data.

In the above examples, the base link is determined in the form of the order of the scheduled travel link (the X-th scheduled travel link). Instead, the base link may be also determined based on a distance or a time, e.g., a link which is positioned a predetermined distance ahead or a link expected to be traveled after a predetermined time passes.

Moreover, not during the route guide but when the guide route is not set, the link connected to the node connected to the present link in the traveling direction of the vehicle may be determined as the base link. Even if the route guide is not executed, since the vehicle is expected to travel into any of the links connected to the nodes ahead of the present link, it is effective to switch the display mode in consideration of the link. In addition, when plural links are connected to the node ahead of the present link, all the links may be determined as the base links, or only the link along the road may be determined as the base link. In addition, only the link corresponding to the large road may be determined as the base link. The link along the road can be the link having an angle, with respect to the present link, equal to or smaller than a predetermined acute angle (e.g., 30 degree). Additionally, whether or not the road is large may be determined on the basis of the road type and/or the road width of the road link.

### Third Embodiment

In the first and second embodiments, the display mode is switched in correspondence with whether or riot the map data in the display mode designated by the user includes the link data of the base link. On the contrary, in a third embodiment, the display mode is switched based on whether or not the present position is on the road in the map data, not based on the existence or nonexistence of the link data. The map data includes the data of the object used at the time of the map display in the map display data shown in FIG. 2, for example. Namely, when a building exists at a certain position, the data showing the object of the building and the position at which the object exists is prepared in order to display the building in the map image. Therefore, by referring to the data of the object, it can be determined whether or not the present position of the vehicle corresponds to the object other than the road, e.g., the building. Thereby, it becomes possible to determine whether or not the vehicle is on the road.

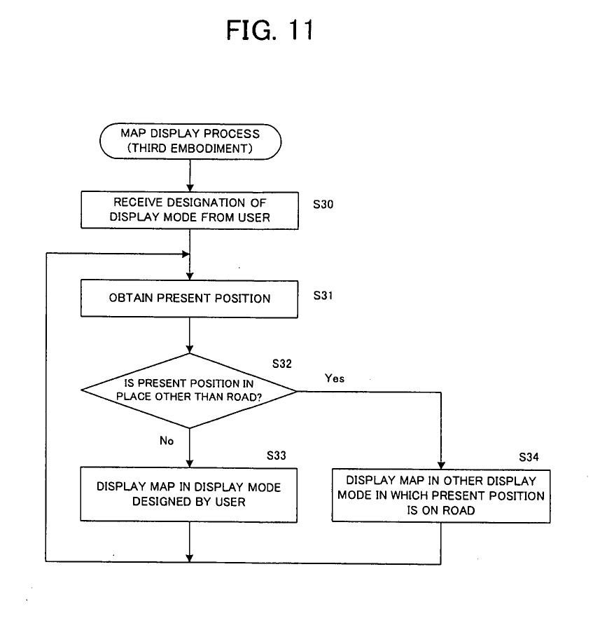

FIG. 11 is a flow chart of the map display process according to the third embodiment. When the CPU 22 executes the map display program prepared in advance, this process is realized.

First, the CPU 22 receives the designation of the display mode from the user via the input device 60 (step S30). Next, the CPU 22 obtains the present position of the vehicle with using the stand-alone position measurement device 10 and the GPS receiver 18 (step S31). Next, the CPU 22 refers to the map data corresponding to the display mode designated by the user, and determines whether or not the present position corresponds to the object other than the road (step S32). When the present position is not the object other than the road (step S32; No), the CPU 22 displays the map in the display mode designated by the user (step S33). Meanwhile, when the present position is the object other than the road (step S32; Yes), the CPU 22 refers to the map data corresponding to the other display mode, and displays the map in the other display mode in which the present position corresponds to the road (step S34).

By the method, when the display mode designated by the user cannot display the new road, it becomes possible to automatically switch the display mode and display the new road, too. Further, by this method, it can be prevented to display the map in which the present position mark moves in the place other than the road, because of low accuracy of the map data, even though the link data of the present position exists in the map data in the display mode designated by the user. Since the accuracy of some map data is not high enough, the actual position of the road and the position of the link in the map data can be different. In this case, since the present position of the vehicle is determined and moved by the map data for the normal map, the map in which the vehicle travels into the position different from the road can be displayed. By the method of the third embodiment, since the display mode can be switched in this case, it can be prevented to display the map in which the vehicle travels into the place other than the road.

### Fourth Embodiment

A fourth embodiment is obtained by combining the first embodiment and the third embodiment. Namely, similarly to the first embodiment, when the link data corresponding to the base link does not exist in the map data corresponding to the display mode designated by the user, the display mode is basically changed. In addition, by adapting the third embodiment, it is determined whether or not the present position is in the place other than the road. Thereby, even when the link data corresponding to the base link exists in the map data corresponding to the display mode designated by the user, it can be prevented to display the map in which the vehicle travels in the place other than the road due to the insufficient accuracy of the map data.

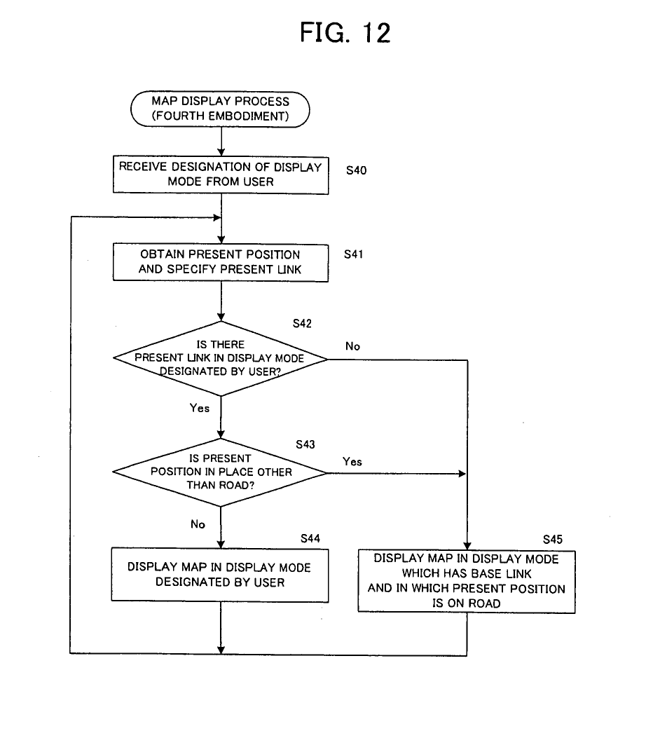

FIG. 12 is a flow chart of the map display process according to the fourth embodiment. When the CPU 22 executes the map display program prepared in advance, this process is realized.

Processes in steps S40 to S42 are same as those in steps S10 to S12 in the first embodiment shown in FIG. 9. In step S42, when it is determined that the link data corresponding to the base link does not exist in the map data in the display mode designated by the user, the process goes to step S45. Meanwhile, in step S42, when it is determined that the link data corresponding to the base link does not exist in the map data in the display mode designated by the user, the CPU 22 refers to the map data corresponding to the display mode designated by the user, and determines whether or not the present position corresponds to the object other than the road (step S43). When the present position is not the object other than the road (step S43; No), the CPU 22 displays the map in the display mode designated by the user (step S44). Meanwhile, when the present position is the object other than the road (step S43; Yes), the CPU 22 refers to the map data corresponding to the other display mode, and displays the map in the other display mode which includes the link data corresponding to the base link, and in which the present position corresponds to the road (step S45).

In the fourth embodiment, even if the link data of the base link is included in the map data in the display mode designated by the user, when the vehicle moves in the place other than the road due to the insufficient accuracy of the map data, the display mode is changed. Thus, it can be prevented to display the movement of the vehicle in the place other than the road due to the difference of the update state of the map data or the accuracy of the map data.

In the above explanation, the third embodiment is applied to the first embodiment. Instead, the third embodiment may be applied to the second embodiment. Namely, not the present link but the scheduled travel link on the guide route is used as the base link, and further, the determination may be executed based on the object of the map data, as described in the third embodiment.

### [Modification]

In the above embodiments, out of all four display modes, the map data for the normal map is always updated first. However, the present invention is not limited to this. In fact, the map data for the normal map is not always the newest map data. Thus, in the above map display process, when the link data of the base link does not exist in the map data in the display mode designated by the user, the display mode may be switched to the other display mode in which the correspondent link data exists, not to the display mode for the normal map.

### INDUSTRIAL APPLICABILITY

This invention can be used for a navigation apparatus of a movable body such as a vehicle.

1-8. (canceled)

9. A navigation apparatus for a movable body, comprising:
a storage unit which stores map data prepared for each display mode;
a present position detection unit which detects a present position of the movable body;
a base link determination unit which determines a base link, which is used as a basis of a display mode change, based on the present position; and
a map display unit which displays a map in a display mode designated by a user,
wherein, when map data corresponding to the display mode designated by the user does not include the base link, the map display unit displays a map in the display mode corresponding to the map data including the base link.

10. The navigation apparatus according to claim 9, wherein the base link is a link corresponding to the present position.

11. The navigation apparatus according to claim 9, further comprising a route guide unit which guides a route to a destination in accordance with a guide route,
wherein the base link is at least one scheduled travel link positioned ahead of a road link corresponding to the present position on the guide route.

12. The navigation apparatus according to claim 9, wherein the base link is a link connected to a node which is connected to the link corresponding to the present position in a traveling direction of the movable body.

13. The navigation apparatus according to claim 9, wherein, when the present position is not on a road in the map data corresponding to the display mode designated by the user, the map display unit displays the map in the display mode including the base link and corresponding to the map data in which the present position is on the road.

14. A map display method in a navigation apparatus for a movable body including map data for each display mode, comprising:
a present position detection process which detects a present position of the movable body;
a base link determination process which determines a base link which is used as a basis of a display mode change, based on the present position; and
a map display process which displays a map in a display mode designated by a user,
wherein, when map data corresponding to the display mode designated by the user does not include the base link, the map display process displays a map in the display mode corresponding to the map data including the base link.

15. A computer program product in a computer-readable medium for map display executed in a navigation apparatus for a movable body including a computer, making the computer function as:
a storage unit which stores map data prepared for each display mode;
a present position detection unit which detects a present position of the movable body;
a base link determination unit which determines a base link which is used as a basis of a display mode change, based on the present position; and
a map display unit which displays a map in a display mode designated by a user,
wherein, when the map data corresponding to the display mode designated by the user does not include the base link, the map display unit displays a map in a display mode corresponding to the map data including the base link.

16. A storage medium which stores the map display program according to claim 15.
